(19) United States
(12) Patent Application Publication
(10) Pub. No.: US 2014/0138549 A1
(43) Pub. Date: May 22, 2014

(54) X-RAY DETECTING DEVICE

(71) Applicant: AbyzR Co., Ltd., Gyeonggi-do (KR)

(72) Inventors: Yun Sung HUH, Gyeonggi-do (KR); Tae Kwon HONG, Gyeonggi-do (KR); Gi Youl HAN, Chungcheongnam-do (KR)

(73) Assignee: AbyzR Co., Ltd., Gyeonggi-do (KR)

(21) Appl. No.: 14/086,671

(22) Filed: Nov. 21, 2013

(30) Foreign Application Priority Data
Nov. 21, 2012 (KR) 10-2012-0132343

(51) Int. Cl. G01T 1/20

(52) U.S. Cl. CPC G01T 1/2006
USPC 250/366

(57) ABSTRACT

Provided is an X-ray detecting device including a scintillator panel, an adhesive layer, an imaging device panel, and so on. The scintillator panel includes a substrate through which an X-ray passes, a reflective layer formed on the substrate and configured to allow penetration of the X-ray and reflect visible light, and a scintillator layer formed on the reflective layer and configured to convert the X-ray into the visible light. The adhesive layer is formed on the scintillator layer of the scintillator panel. The imaging device panel is coupled on the adhesive layer and has a plurality of light receiving elements and a plurality of electrode pads installed at a surface thereof directed toward the adhesive layer.

### CROSS-REFERENCE TO RELATED APPLICATIONS

Claim and incorporate by reference domestic priority application and foreign priority application as follows:

### “CROSS REFERENCE TO RELATED APPLICATION

This application claims the benefit under 35 U.S.C. Section 119 of Korean Patent Application Serial No. 10-2012-0132343, entitled filed Nov. 21, 2012, which is hereby incorporated by reference in its entirety into this application.”

### BACKGROUND OF THE INVENTION

1. Field of the Invention

The present invention relates to an X-ray detecting device, and more particularly, to an indirect type X-ray detecting device configured by laminating a scintillator panel and an imaging device panel.

2. Description of the Related Art

In the case of medical X-ray photography, the digital radiation imaging devices have been widely used to identify the images using the radiation detectors without the use of the film.

The digital radiation imaging devices can be classified into a direct conversion method and an indirect conversion method, the direct conversion method is a method to implement the images by directly converting the irradiated X-ray into an electric signal and the indirect conversion method is a method to implement the images after converting the X-ray into the visible light and converting the visible light into the electric signal by using an imaging device such as a photodiode, a CMOS and a CCD sensor or the like.

In the case of the indirect conversion method, a scintillator is used to convert the X-ray into the visible light and the method is classified into a direct method and an indirect method according to a method of integrating the scintillator and the imaging device. The direct method is to directly deposit the scintillator layer on the imaging device and the indirect method is to separately manufacture a scintillator panel obtained by depositing the scintillator layer on a substrate and to laminate it to the imaging device panel by using an adhesive.

In the indirect method, when the scintillator panel and the imaging device panel are combined, a method such as a double-sided tape attachment, an adhesive solution attachment and a vacuum attachment or the like has been used.

The double-sided tape attachment is a method to laminate the scintillator panel and the imaging device panel on both sides of the double-sided tape, respectively, and the adhesive solution attachment is a method to dispose an adhesive solution between the scintillator panel and the imaging device panel and curing the adhesive solution. However, since the double-sided attachment and the adhesive solution attachment are performed at the normal pressure, the moisture in the air may deteriorate the characteristics of Csl, and thus, “a protective film deposition process” is needed. As a result, observing a cross-sectional view of the X-ray detecting device, the device includes the protective film in addition to the double-sided tape or the adhesive solution.

The vacuum attachment aligns the scintillator panel and the imaging device panel in the vacuum chamber to face each other and then seals the edges thereof. When the sealed scintillator panel and the imaging device panel are placed under the normal pressure, the faced surfaces of the scintillator panel and the imaging device panel are pressurized to each other by the external pressure. But, in this method, while the method has a simple structure in external appearance because no element is disposed between the scintillator panel and the imaging device panel, since the facing surfaces of the scintillator panel and the imaging device panel may be bent inward by the external pressure, the optical path difference may occur in the visible light passing therethrough. In addition, since the X-ray detecting device configured through the vacuum attachment should have a separate sealing member to form a vacuum space between the scintillator panel and the imaging device panel, it is difficult to say that the structure is simplified.

As described above, the conventional indirect type X-ray detecting device has various types of structures according to a manufacturing method thereof. However, the conventional X-ray detecting device should have a scintillator protective film or a separate sealing member, which cause complexity of the structure. In addition, the conventional X-ray detecting device cannot be easily manufactured due to structural characteristics thereof, and further, optical transmittance is insufficient or the scintillator layer or the light receiving element cannot be sufficiently protected from external impacts.

### SUMMARY OF THE INVENTION

The present invention has been invented in order to overcome the above-described structural problems of the conventional X-ray detecting device and it is, therefore, an object of the present invention to provide an X-ray detecting device capable of, first, increasing optical transmittance, second, sufficiently preventing damage to a scintillator layer or a light receiving element, and third, simplifying a manufacturing process to reduce manufacturing cost.

In order to solve the problems, an X-ray detecting device of the present invention includes a scintillator panel, an adhesive layer, and an imaging device panel.

The scintillator panel includes a substrate through which an X-ray passes, a reflective layer formed on the substrate to allow penetration of the X-ray and reflect visible light, and a scintillator layer formed on the reflective layer and configured to convert the X-ray into the visible light.

The adhesive layer is formed on the scintillator layer of the scintillator panel.

The imaging device panel is coupled on the adhesive layer and has a plurality of light receiving elements and a plurality of electrode pads on a surface thereof directed toward the adhesive layer.

In the X-ray detecting device, the adhesive layer is formed through thermal bonding of an EVA (ethylene vinyl acetate) sheet, a PC (polycarbonate) sheet, a PVB (polyvinyl butyral) sheet, or a silicon-based organic-thermoplastic sheet.

In the X-ray detecting device, the reflective layer may be formed of any one of a dual structure of a metal layer and a polymer layer, a dual structure of an oxide layer and a polymer layer, a single structure of an oxide layer, and a triple structure of a metal layer, an oxide layer and a polymer layer.

The X-ray detecting device may further include an oxide layer disposed between the scintillator layer and the adhesive layer and configured to allow penetration of the visible light and block penetration of moisture. The oxide layer may have a multi-layered structure formed by depositing a first oxide layer having a refractive index of 1.0 or more and less than 2.0 and a second oxide layer having a refractive index of 2.0 or more and less than 3.0.

The X-ray detecting device may further include a protective film disposed between the oxide layer and the adhesive layer.

A variant of the X-ray detecting device of the present invention includes a scintillator panel, a polymer adhesive layer, and an imaging device panel.

The scintillator panel includes a substrate through which an X-ray passes, a reflective layer formed on the substrate and configured to allow penetration of the X-ray and reflect visible light, a scintillator layer formed on the reflective layer and configured to convert the X-ray into the visible light, and a polymer layer formed on the scintillator layer and configured to allow penetration of the visible light and block penetration of moisture.

The polymer adhesive layer is thermally bonded onto the polymer layer of the scintillator panel.

The imaging device panel is coupled to the polymer adhesive layer through thermal bonding of the polymer adhesive layer and has a plurality of light receiving elements and a plurality of electrode pads installed at a surface thereof directed toward the polymer adhesive layer.

In the variant of the X-ray detecting device of the present invention, the adhesive layer may be formed by using an EVA (ethylene vinyl acetate) sheet, a PC (polycarbonate) sheet, a PVB (polyvinyl butyral) sheet, or a silicon-based organic-thermoplastic sheet.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a first embodiment of an X-ray detecting device according to the present invention;

FIG. 2 is a second embodiment of the X-ray detecting device according to the present invention;

FIG. 3 is a third embodiment of the X-ray detecting device according to the present invention; and

FIG. 4 is a fourth embodiment of the X-ray detecting device according to the present invention.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

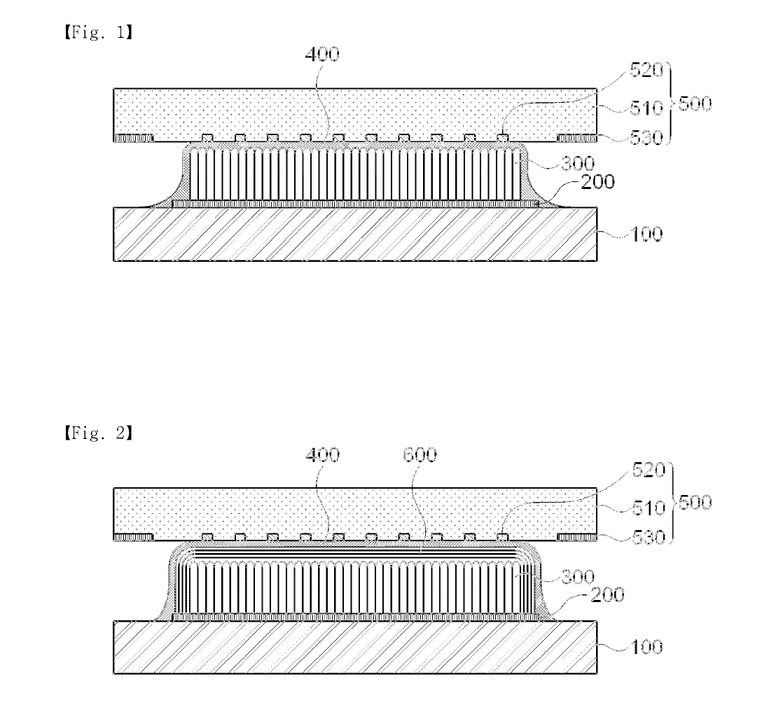

FIG. 1 shows a first embodiment of an X-ray detecting device according to the present invention.

As shown in FIG. 1, the first embodiment of the X-ray detecting device includes scintillator panels 100, 200 and 300, an adhesive layer 400, and an imaging device panel 500.

The scintillator panels are constituted by a substrate 100, a reflective layer 200 and a scintillator layer 300.

The substrate 100 is formed of a material through which an X-ray passes, for example, aluminum, glass, Pyrex, or the like, having a thickness of 1 mm or less. In the case of amorphous carbon (a-C) (glassy carbon), since the substrate 100 has a certain level of stiffness even when an area thereof is increased, bending of the substrate 100 can be suppressed even when the scintillator layer 300 is formed on the substrate 100.

The reflective layer 200 is formed of a material that allows an X-ray passing through the substrate 100 to pass through the scintillator layer 300 and that reflects visible light converted through the scintillator layer 300. The reflective layer 200 is generally formed of a reflective metal thin film. For example, while silver (Ag) or aluminum (Al) is mainly used, Cr, Cu, Ni, Ti, Mg, Rh, Pt, Au, or the like, may also be used. In addition, a multi-metal layer may be used, for example, a Cr film is first formed and an Au film is formed thereon, or the like.

The reflective layer 200 may be formed of an oxide layer having a cutoff filter function. The oxide layer may be configured by depositing a first oxide layer having a refractive index of 1.0 or more and less than 2.0 and a second oxide layer having a refractive index of 2.0 or more and less than 3.0 in a plurality of layers, and reflects visible light generated from the scintillator layer 300.

The reflective layer 200 may be configured as a dual structure by adding an oxide layer on the metal layer of Ag, Al, or the like. In addition, the reflective layer 200 may be configured as a triple structure by adding, for example, a polymer layer of parylene on the oxide layer.

In addition, reflective layer 200 may be configured as a dual structure of the above-mentioned oxide layer and a polymer layer deposited thereon.

The scintillator layer 300 is deposited on the reflective layer 200. The scintillator layer 300 is deposited in a columnar structure. Each columnar structure of the scintillator layer 300 has a sharp shape, an apex of which is not flat and a diameter of which is reduced toward the apex. A thickness of the scintillator layer 300 is about 20 to 2000 μm. The scintillator layer 300 converts the incidence radiation into light in a visible range that can be detected by a light receiving element 520.

The kind of the scintillator layer 300 is not limited as long as the radiation can be converted into the visible light. For example, the scintillator 300 may use Csl, thallium (Tl)-doped Csl, sodium (Na)-doped Csl, thallium (Tl)-doped Nal, and so on. Among them, since the thallium (Tl)-doped Csl has good emission efficiency while emitting the visible light, the thallium (Tl)-doped Csl may be used.

The Csl is a moisture-absorbing material, which forms the scintillator layer 300, and melted when the Csl absorbs steam in the air (moisture). That is, when the steam comes in contact with the scintillator layer 300, the scintillator layer 300 is damaged to decrease resolution of an image obtained from the imaging device. Accordingly, it is important to block the scintillator layer 300 from the moisture.

The adhesive layer 400 is disposed on the scintillator layer 300 of the scintillator panels. The adhesive layer 400 couples the scintillator panels and the imaging device panel. The adhesive layer 400 is disposed between the scintillator layer 300 of the scintillator panels and a surface of a light receiving element of the imaging device panel 500, and then, melted by heating to be coupled to the scintillator layer 300 and the surface of the light receiving element of the imaging device panel 500.

The adhesive layer 400 also functions to protect the scintillator layer 300 from external moisture. Accordingly, the adhesive layer 400 is configured to completely cover an outer surface of the scintillator layer 300.

The adhesive layer 400 is formed by thermal bonding of an EVA (ethylene vinyl acetate) sheet, a PC (polycarbonate) sheet, a PVB (polyvinyl butyral) sheet, or a silicon-based organic-thermoplastic sheet. For example, in the case of the EVA sheet, an adhesive sheet formed by adding organic peroxide to ethylene copolymer resin in which ethylene copolymer resin having a vinyl acetate content of 30 to 36% and ethylene copolymer resin having a vinyl acetate content of 24 to 30% are mixed at a ratio of 90:10 to 10:90 may be used.

The ethylene copolymer may be ethylene vinyl ester copolymer such as ethylene acetic acid vinyl copolymer, ethylene unsaturated carboxylic acid ester copolymer such as ethylene-acrylic acid methyl copolymer, ethylene acrylic acid ethyl copolymer, ethylene meta acrylic acid methyl copolymer, ethylene acrylic acid isobutyl copolymer, or ethylene acrylic acid n-butyl copolymer, ethylene unsaturated carboxylic acid copolymer such as ethylene acrylic acid copolymer, ethylene meta acrylic acid copolymer, ethylene acrylic acid isobutyl-meta acrylic acid copolymer, or the like. In consideration of compatibility of required properties of the adhesive sheet such as formability, transparency, flexibility, adhesive property, light resistance, and so on, impregnation property of the organic peroxide, or the like, the ethylene acetic acid vinyl copolymer may be used.

As the ethylene acetic acid vinyl copolymer that came into the market may be MA-10 (a vinylacetate content is 32%, and a melt flow rate is 40 g/10 minutes) and KA-40 (a vinyl acetate content is 28%, and a melt flow rate is 20 g/10 minutes) of TPC, PV 1650 (a vinyl acetate content is 33%, and a melt flow rate is 31 g/10 minutes), PV 1400 (a vinyl acetate content is 32%, and a melt flow rate is 43 g/10 minutes) and PV 1410 (a vinyl acetate content is 32%, and a melt flow rate is 43 g/10 minutes) of Du Pont, and so on.

As the organic peroxide, a dialkyl peroxide type, an alkyl peroxy ester type, or a peroxy ketone type may be selected and used. The organic peroxide of 0.2 to 4 weight % may be used with respect to ethylene copolymer resin of 100 weight %.

The imaging device panel 500 has the light receiving element 520 directed to the scintillator layer 300 to be coupled to the scintillator layer 300 via the adhesive layer 400. The imaging device panel 500 includes a substrate 510, the light receiving element 520, an electrode pad 530, and so on. The plurality of light receiving elements 520 are installed at a central portion of the substrate 510, and the plurality of electrode pads 530 are installed at an edge surface of the substrate 510.

FIG. 2 shows a second embodiment of the X-ray detecting device according to the present invention.

The second embodiment of FIG. 2 further includes an oxide layer 600 disposed between the scintillator layer 300 and the adhesive layer 400 and configured to allow penetration of the visible light and prevent penetration of the moisture, in addition to the first embodiment.

The oxide layer 600 is disposed on the scintillator layer 300, and functions to transmit the visible light converted by the scintillator layer 300 to the light receiving element 520 of the imaging device therethrough. In addition, the oxide layer 600 functions to block penetration of the moisture and protect the scintillator layer 300 from the moisture.

The oxide layer 600 may be formed of an oxide film of metal such as SiO₂, TiO₂, Ta₂O₃, or the like.

The oxide layer 600 may be configured through physical vapor deposition such as electron beam deposition, sputtering or thermal deposition, chemical vapor deposition, or the like. However, when the oxide layer 600 is deposited on the entire surface of the scintillator layer 300, a sputtering method may be used under a process pressure atmosphere having good step coverage. A preferable process pressure of the sputtering method is tens to hundreds mTorr.

The oxide layer 600 may be configured to penetrate a specific wavelength range of the visible light. The visible light generally has a wavelength 400 to 700 nm, specifically, a blue range of 400 to 500 nm, a green range of 500 to 600 nm, and a red range of 600 to 700 nm. However, the light receiving element 520 may not receive the entire range of visible light according to a depth of the light receiving element formed in the substrate of the imaging device. For example, when the light receiving element 520 is formed at a depth of 4 to 5 μm from the substrate 510, the wavelength of the blue range and the wavelength of the green range can be detected by the light receiving element 520, but the visible light of the red range of 600 to 700 nm cannot be received by the light receiving element 520. Accordingly, since an effective wavelength band of the visible light to be penetrated is determined according to a formation depth of the light receiving element 520, transmissivity of the visible light should be maximized at an effective penetration band having a band pass filter function when the oxide layer 600 is configured.

Meanwhile, as shown in FIG. 2, the oxide layer 600 may be configured by sequentially forming an oxide layer of a medium 1 having a refractive index of 1.0 or more and less than 2.0 and an oxide layer of a medium 2 having a refractive index of 2.0 or more and less than 3.0. Here, the oxide layer in contact with the scintillator layer 300 may be the medium 1 or the medium 2. However, the medium having the refractive index closest to the refractive index of the scintillator layer 300 may be first deposited on the scintillator layer 300.

When the oxide layer 600 is configured as a layered structure, the number of layers may be, for example, 2 to 31. In this case, the thickness of each oxide layer and the number of layers can be adjusted such that the light of the visible range generated from the scintillator layer 300 can be optimally penetrated due to a function of the band pass filter in the oxide layer 600. As a result, the visible light generated from the scintillator layer 300 can be penetrated in the adhesive layer 400 to almost 100%.

The scintillator layer 300 is sealed to side surfaces thereof as well as an upper surface by the oxide layer 600. As a result, the oxide layer 600 can block penetration of the moisture to protect the scintillator layer 300.

The adhesive layer 400 is formed on the oxide layer 600. That is, the adhesive layer 400 is disposed between the oxide layer 600 and the imaging device panel 500, and fused on the surfaces of the oxide layer 600 and the light receiving element 520 of the imaging device panel 500 to couple the scintillator panel and the imaging device panel.

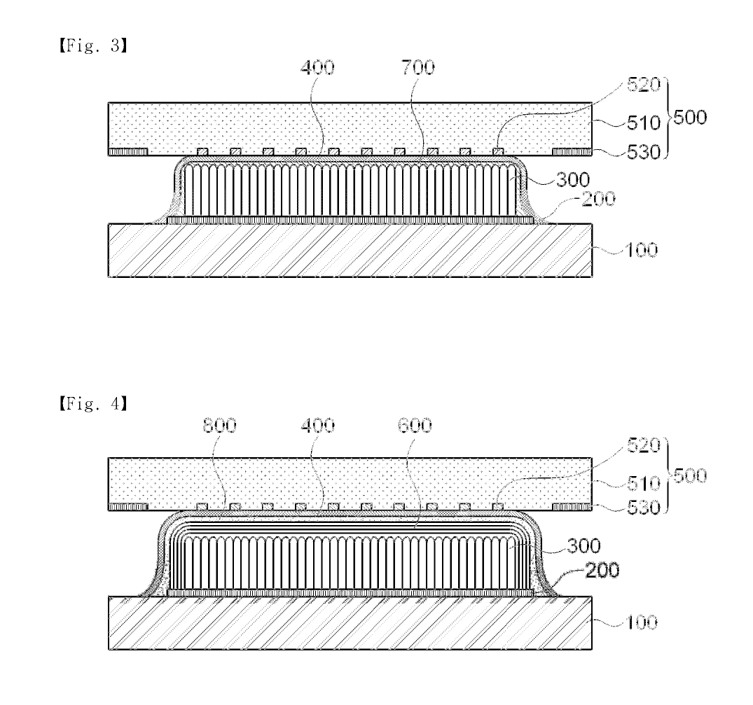

FIG. 3 shows a third embodiment of the X-ray detecting device according to the present invention.

As shown in FIG. 3 the third substrate includes a protective film 700, instead of the oxide layer 600 of FIG. 2, on the scintillator layer 300.

The protective film 700 may be any film as long as the moisture is blocked and the visible light passes therethrough. For example, an organic resin, specifically, parylene resin may be used. The parylene may be parylene N, parylene C, parylene D, parylene AF-4, and so on, which are trade names of chemically deposited polyparaxylene polymer. A film coated with the parylene has low penetration property of moisture or a gas, and good hydrophobicity, chemical resistance and electric insulation. In addition, the parylene allows penetration of the visible light.

The protective film 700 may be deposited under vacuum through physical vapor deposition (PVD) or chemical vapor deposition (CVD).

FIG. 4 shows a fourth embodiment of the X-ray detecting device according to the present invention.

The fourth embodiment of FIG. 4 further includes a protective film 800 between the oxide layer 600 and the adhesive layer 400 of the second embodiment.

The protective film 800 of FIG. 4 uses the same as or a similar to the protective film 700 of FIG. 3. That is, the protective film 800 may be any film as long as the film blocks the moisture and allows penetration of the visible light. For example, an organic resin, specifically, parylene resin may be used.

Detailed description of the other components, i.e., the adhesive layer 400, the oxide layer 600, and so on, will be substituted with the description of FIG. 2.

As can be seen from the foregoing, according to the X-ray detecting device of the present invention having the above-mentioned configuration, the visible light generated from the scintillator layer can sufficiently pass through the light receiving element, and perform a shock absorbing action between the scintillator layer and the light receiving element to prevent damage to the scintillator layer or the light receiving element. In addition, a manufacturing process can be simplified to reduce manufacturing cost.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. An X-ray detecting device comprising:
a scintillator panel comprising a substrate through which an X-ray passes, a reflective layer formed on the substrate to penetrate the X-ray and to reflect visible light, and a scintillator layer formed on the reflective layer and configured to convert the X-ray into the visible light;
an adhesive layer formed on the scintillator layer of the scintillator panel; and
an imaging device panel coupled on the adhesive layer and having a plurality of light receiving elements and a plurality of electrode pads on a surface thereof facing toward the adhesive layer.

2. The X-ray detecting device according to claim 1, further comprising an oxide layer disposed between the scintillator layer and the adhesive layer, and configured to penetrate the visible light and to block moisture.

3. The X-ray detecting device according to claim 2, further comprising a protective film disposed between the oxide layer and the adhesive layer.

4. The X-ray detecting device according to claim 1, wherein the adhesive layer is formed through thermal bonding of an EVA (ethylene vinyl acetate) sheet, a PC (polycarbonate) sheet, a PVB (polyvinyl butyral) sheet, or a silicon-based organic-thermoplastic sheet.

5. The X-ray detecting device according to claim 4, wherein the reflective layer is formed of any one of a dual structure of a metal layer and a polymer layer, a dual structure of an oxide layer and a polymer layer, a single structure of an oxide layer, and a triple structure of a metal layer, an oxide layer and a polymer layer.

6. The X-ray detecting device according to claim 2, wherein the oxide layer has a multi-layered structure formed by depositing a first oxide layer having a refractive index of 1.0 or more and less than 2.0 and a second oxide layer having a refractive index of 2.0 or more and less than 3.0.

7. An X-ray detecting device comprising:
a scintillator panel comprising a substrate through which an X-ray passes, a reflective layer formed on the substrate and configured to allow the X-ray to penetrate and visible light to reflect, a scintillator layer formed on the reflective layer and configured to convert the X-ray into the visible light, and a polymer layer formed on the scintillator layer and configured to penetrate the visible light and to block moisture;
an adhesive layer thermally bonded onto the polymer layer of the scintillator panel; and
an imaging device panel coupled to the polymer adhesive layer through thermal bonding of the polymer adhesive layer and having a plurality of light receiving elements and a plurality of electrode pads installed at a surface thereof directed toward the polymer adhesive layer.

8. The X-ray detecting device according to claim 7, wherein the adhesive layer is formed by using an EVA (ethylene vinyl acetate) sheet, a PC (polycarbonate) sheet, a PVB (polyvinyl butyral) sheet, or a silicon-based organic-thermoplastic sheet.
